(19) United States
(12) Patent Application Publication
(10) Pub. No.: US 2026/0328994 A1
(43) Pub. Date: Oct. 22, 2026

(54) HOLLOW CORE FIBER PERFORM ASSEMBLY

(71) Applicant: STERLITE TECHNOLOGIES LIMITED, Gurugram (IN)

(72) Inventors: Ranjith Balakrishnan, Gurugram (IN); Srinivas Munige, Gurugram (IN); Anand Pandey, Gurugram (IN)

(21) Appl. No.: 19/634,916

(22) Filed: Mar. 31, 2026

(30) Foreign Application Priority Data
Apr. 21, 2025 (IN) 202511038012

(51) Int. Cl. G02B 6/02; C03B 37/012; C03B 37/014; C03B 37/027

(52) U.S. Cl. CPC G02B 6/02361; C03B 37/0122; C03B 37/01242; C03B 37/01446; C03B 37/02781; G02B 6/02042; G02B 6/02371; C03B 2203/16; C03B 2203/22; C03B 2203/42

(57) ABSTRACT

The present invention relates to a hollow core glass preform (100) assembly comprises a first cylindrical hollow tube (102) defined by a first diameter, a plurality of second tubes (106) disposed within the first cylindrical hollow tube (102) to form a hollow core region (108) and an integrated aligning element (112) configured to hold the plurality of second tubes (106) at a predetermined position with respect to the first cylindrical hollow tube (102). In particular, the integrated aligning element (112) is a single component element. Further, the integrated aligning element (112) is configured to be inserted on at least one end (130) the first cylindrical hollow tube (102).

### CROSS-REFERENCE TO RELATED APPLICATIONS

This application claims the benefit of Indian Provisional Application No. IN202511038012, titled “HOLLOW CORE FIBER PERFORM ASSEMBLY” filed by the applicant ON 21^{st} April 2026, which is incorporated herein by reference in its entirety.

### FIELD OF THE INVENTION

Embodiments of the present invention relate to the field of optical fiber cables and more particularly relates to a hollow core optical fiber perform assembly.

### DESCRIPTION OF THE RELATED ART

Optical fiber is increasingly being used for a variety of applications, including broadband applications such as voice, video and data transmissions. It is a current trend in telecommunications to use optical fibers in place of the more conventional transmission media. As a result, fiber optic communication systems are becoming prevalent in part because service providers want to deliver high bandwidth communication capabilities to customers.

Solid core fibers are suitable for a wide range of applications but can suffer from higher latency, higher non-linear effects, and higher dispersion while a hollow core fiber offers lower latency, reduced non-linear effects, and lower dispersion, making it advantageous for specific high-performance applications. The hollow-core fiber is an optical fiber which guides light essentially within a hollow region, so that only a minor portion of the optical power propagates in the solid fiber material (typically a glass).

The existing hollow-core fibers offer significant advantages, such as lower signal attenuation and faster transmission speeds, but their manufacturing presents several challenges. One key issue is non-accurate aligning and positioning of multiple anti-resonant cladding tubes within a jacket tube along with ineffective pressurization capability.

U.S. Pat. No. 11,215,751B2 uses multiple spacing elements to secure the anti-resonant cladding tubes, but misalignment can still occur, affecting hollow-core fiber performance.

Another US patent application US20240036248A1, filling gaps between nested cladding tubes with smaller cladding material ensures their position but adds complexity, increases production costs, and can lead to performance inconsistencies due to varying material properties.

Yet another US patent application US20240034665A1, lacks the need of simple alignment of resonant tubes as well as an effective way to provide positive pressure in the HCF preform assembly. The prior art uses multiple alignment steps which increases complexity as well increases wastage of HCF preform.

Another challenge in prior arts is maintaining precise pressure conditions during the drawing process. The stack-and-draw technique, as described in a literature entitled “Stack, seal, evacuate, draw,” uses a slit in the jacket tube to apply positive pressure. While this method helps form the hollow-core fiber, it can lead to mechanical issues like leaks or deformations in the jacket tube, which complicate the process. These difficulties hinder the scalability and cost-effectiveness of hollow-core fiber production, highlighting the need for improved manufacturing methods.

As illustrated in FIG. 1 a hollow core anti-resonant node-less fiber (hereinafter interchangeably referred as hollow core anti-resonant fiber or hollow core fiber) (10). An optical signal in the hollow core anti-resonant fiber (10) propagate in an air core region (12) surrounded by a plurality of anti-resonant tube elements (14). Guidance is based on an anti-resonance from the thin glass tube (16) constituted by the non-touching tubes surrounding the hollow core.

Further, FIG. 2 and FIG. 3 illustrates a first critical step while drawing of nested anti-resonant node less fiber (NANF)(10) (i.e., hollow core fiber) is proper and accurate alignment of the nested anti resonant (AS) tubes (18) inside a jacket tube (20) to form an air core region (22). As shown below in FIG. 3, a hollow core fiber (HCF) preform is made by stacking AS tubes (18) inside the jacket tube (20). After the AS tubes stacking, one or more spacing elements, spacing rods, support tubes (24) are placed on both top and bottom side of the HCF preform to keep the AS tubes in a target position. The need of one or more spacing plates, spacing rods, support tubes (24) leads to manufacturing of different sized rods, plates and tubes, which is time consuming and not precise to position the AS tubes (18) inside the jacket tube (20) at the target position.

Because of multiple spacing components as required for alignment of AS tubes (18), it becomes complex and challenging in the known techniques of assembling of HCF preform. A second critical step while drawing NANF (10) hollow core fiber is individual pressurization of the air core region (22) and the AS tubes (18) with differential pressure.

In one of the known methods in the prior art, UV curable epoxy resins are used to separate the core region and the AS tubes. Another known method in the prior art is to create a slit and close one side of the HCF, perform assembly and reverse, closing another side with positive pressure. Both the known methods increase process steps, complexity and are inefficient.

Another major drawback of the known methods is that 30% to 40% of the HCF preform can't be drawn. In the first method, the UV resins will melt and reach up to ⅓^{rd} region from the top end of the HCF preform. In the second method, slit will get closed at around 70% draw length of the HCF preform leads to wastage of the HCF preform.

Accordingly, to overcome the disadvantages of the prior arts, there is a need to provide a better HCF drawing technique to solve the aforementioned problems. The present invention provides an anti-resonant hollow-core fiber and a preform for anti-resonant hollow-core fibers, and a method for producing thereof.

### SUMMARY OF THE INVENTION

Embodiments of the present invention provide a hollow core glass preform assembly comprising a first cylindrical hollow tube defined by a first diameter; a plurality of second tubes disposed within the first cylindrical hollow tube to form a hollow core region; and an integrated aligning element configured to hold the plurality of second tubes at a predetermined position with respect to the first cylindrical hollow tube, where the integrated aligning element is a single component element, where the integrated aligning element is configured to be inserted on at least one end the first cylindrical hollow tube.

In accordance with an embodiment of the present invention, the integrated aligning element has a plurality of through holes for each second tube of the plurality of second tubes to protrude through the integrated aligning element, when the integrated aligning element is configured to be inserted at a top end of the first cylindrical hollow tube. In particular, the integrated aligning element has a plurality of groove features to hold each second tube of the plurality of second tubes, when the integrated aligning element is configured to be inserted at a bottom end of the first cylindrical hollow tube. Further, the integrated aligning element has a central hole positioned near the central axis of the hollow core glass preform assembly such that a perpendicular distance between a center of the central hole and the central axis is less than 0.5 mm.

In accordance with an embodiment of the present invention, the integrated aligning element is inserted in 3 to 10% of longitudinal length of the first cylindrical hollow tube.

In accordance with an embodiment of the present invention, the integrated aligning element comprises a circumferential groove configured to attach a holding mechanism. It further comprises one or more spacer plate placed above the protruded second tubes, where the one or more spacer plate comprises a pressure inlet configured to enable application of positive pressure in the plurality of second tubes. Specifically, each second tube of the plurality of second tubes is a cylindrical tube defined by a second diameter, where the second diameter is less than the first diameter.

In accordance with an embodiment of the present invention, the plurality of second tubes has at least one or a down doped region or an Alumina doped region. Further, the plurality of second tubes has at least one or an up doped region or the plurality of second tubes are free from any dopants.

In accordance with an embodiment of the present invention, the first cylindrical hollow tube has a down doped region or an alumina barrier region. Further, a ratio of cross-sectional area of the first cylindrical hollow tube and a sum of cross-sectional area of the plurality of second tube is in a range of 2 to 5.

In accordance with an embodiment of the present invention, a ratio of cross-sectional area of the first cylindrical hollow tube and a sum of cross-sectional area of the plurality of second tube is in a range of 2.5 to 4. Further, each second tube of the plurality of second tubes comprising at least one third tube positioned within each second tube.

In accordance with an embodiment of the present invention, the first cylindrical hollow tube is defined by a first longitudinal length and the second tube is defined by a second longitudinal length such that the first longitudinal length is less than second longitudinal length. The integrated aligning element is made of one of a pure silica glass, soft glass, or polymer material. Further, a hollow core optical fiber is manufactured using the hollow core preform assembly.

In accordance with an embodiment of the present invention, the first cylindrical hollow tube has a uniform wall thickness along its entire longitudinal length, within a tolerance of ±5% of the nominal wall thickness. Moreover, the second tubes are arranged in a radial pattern inside the first cylindrical hollow tube with an angular separation between each second tube of greater than or equal to 55 degrees.

In accordance with an embodiment of the present invention, the integrated aligning element is designed with a stepped outer surface to facilitate secure insertion into the first cylindrical hollow tube and prevent axial movement during handling. Further, the second tubes are arranged in a staggered pattern with respect to the first cylindrical hollow tube, creating a symmetrical geometry along the longitudinal axis of the hollow core glass preform assembly.

In accordance with an embodiment of the present invention, the integrated aligning element comprises a series of radially disposed pins that precisely position each second tube at a predetermined distance from the central axis of the first cylindrical hollow tube.

Another embodiment of the present invention discloses a method for manufacturing a hollow core optical fiber having a hollow core region extending along a longitudinal axis of the hollow core optical fiber, the method comprising forming an intermediate hollow core glass preform assembly, where the intermediate hollow core glass preform assembly comprising a first cylindrical hollow tube; a plurality of second tubes disposed inside the first cylindrical hollow tube to form the hollow core region; and an integrated aligning element configured to be inserted at one of the end of the first cylindrical hollow tube for holding each second tube of the plurality of second tubes; and drawing the intermediate hollow core glass preform assembly in a furnace to obtain the hollow core optical fiber in presence of positive pressure.

Further, holding the plurality of second tubes comprising arranging each second tube at a predetermined position with respect to the first cylindrical hollow tube.

In accordance with an embodiment of the present invention, the method further comprising, stretching the intermediate hollow core glass preform to obtain a low diameter hollow core glass preform.

In accordance with an embodiment of the present invention, the method further comprises, applying individual pressure in the hollow core region and each second tube of the plurality of second tubes.

In accordance with an embodiment of the present invention, the method further comprises applying positive pressure in the hollow core region via a central hole in the integrated aligning element.

In accordance with an embodiment of the present invention, where the integrated aligning element is configured to be inserted at a top end of the first cylindrical hollow tube such that each second tube of the plurality of second tubes protrudes through a plurality of through holes configured in the integrated aligning element.

In accordance with an embodiment of the present invention, an individual positive pressure is applied to each protruded second tube of the plurality of second tubes. Further, the integrated aligning element is configured to be inserted at a bottom end of the first cylindrical hollow tube such that each second tube of the plurality of second tubes is fixed in a plurality of groove features in the integrated aligning element.

In accordance with an embodiment of the present invention, the method further comprises applying one or more coating layers on the drawn hollow core optical fiber to obtain a coated optical fiber, wherein a coating thickness of the one or more coating layers is in a range of 20 microns to 100 microns.

In accordance with an embodiment of the present invention, the hollow-core optical fiber has at least one of (i) a minimum confinement loss of a fundamental mode of an optical signal propagating in the hollow-core optical fiber is less than or equal to 0.05 dB/km at 1550 nm or (ii) an attenuation of less than or equal to 0.1 dB/km at 1550 nm.

In various embodiments, the invention may optionally include applying positive pressure to the hollow core region (108) through a central hole formed in the integrated aligning element (112), while alternative approaches for hollow core pressurization may also be employed. In some implementations, each second tube of the plurality of second tubes (106) may optionally protrude through corresponding or multiple through holes (114) in the integrated aligning element (112), which itself may optionally be formed as a single monolithic body rather than as an assembly of multiple separable components. Further optionally, one or more of the following conditions may be satisfied to enhance drawing performance and structural stability: positional stability of the second tubes may be maintained by pressure forces applied through the same structural features defining their alignment; all alignment and pressurization of the second tubes may be performed exclusively from a single longitudinal end of the intermediate hollow core glass preform assembly (100); at least 85% of the longitudinal length of the preform may be drawable prior to collapse, sealing, or loss of pressure control; positive pressure applied to at least two of the second tubes may differ by at least 5% during drawing; and no adhesive, resin, or gap-filling material may be present between the second tubes and the first cylindrical hollow tube (102). In additional embodiments, the integrated aligning element (112) may optionally define separate pressure inlets for each second tube and for the hollow core region, may be removably inserted without being fused to the first cylindrical hollow tube, and may maintain structural integrity at temperatures exceeding 1800 °C during drawing, thereby providing advantageous control over alignment, pressurization, and draw stability.

The foregoing objectives of the present invention are attained by employing a hollow core fiber.

### BRIEF DESCRIPTION OF THE DRAWINGS

So that the manner in which the above recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The invention herein will be better understood from the following description with reference to the drawings, in which

FIG. 1 is a snapshot illustrating a cross-sectional view of node-less anti-resonant hollow core fiber known in the art.

FIG. 2 is a snapshot illustrating a cross-sectional view of node-less double nested anti-resonant hollow core fiber known in the art.

FIG. 3 is a snapshot illustrating a cross-sectional view of HCF preform assembly known in art having multiple spacing elements used for alignment of second tube (anti-resonant tubes).

FIG. 4 is a snapshot illustrating cross-sectional view of multicore HCF preform assembly in accordance with a second embodiment of the invention;

FIG. 5 is a snapshot illustrating a hollow core glass preform assembly in accordance with a first embodiment of the invention;

FIG. 6A, FIG. 6B and FIG. 6C is a snapshot illustrating a double nested tubes, a triple nested tubes and four tubes are nested respectively in accordance with a second embodiment of the invention;

FIG. 7 is a snapshot illustrating a top plug dimension in accordance with a first embodiment of the invention;

FIG. 8 is a snapshot illustrating a bottom plug dimension in accordance with a second embodiment of the invention;

FIG. 9 is a snapshot illustrating a hollow core glass preform assembly dimensions in accordance with a second embodiment of the invention;

FIG. 10A is a snapshot illustrating a top view of top plug for elliptical resonant tubes in circular pattern in accordance with a second embodiment of the invention;

FIG. 10B is a snapshot illustrating a top view of top plug for semicircular resonant tubes in circular pattern in accordance with a second embodiment of the invention; and

FIG. 11 is a flowchart illustrating a process for preparation of hollow core fiber in accordance with a first embodiment of the invention.

The optical fiber cable illustrated in the accompanying drawings, which like reference letters indicate corresponding parts in the various figures. It should be noted that the accompanying figure is intended to present illustrations of exemplary embodiments of the present invention. This figure is not intended to limit the scope of the present invention. It should also be noted that the accompanying figure is not necessarily drawn to scale.

### DETAILED DESCRIPTION OF THE INVENTION

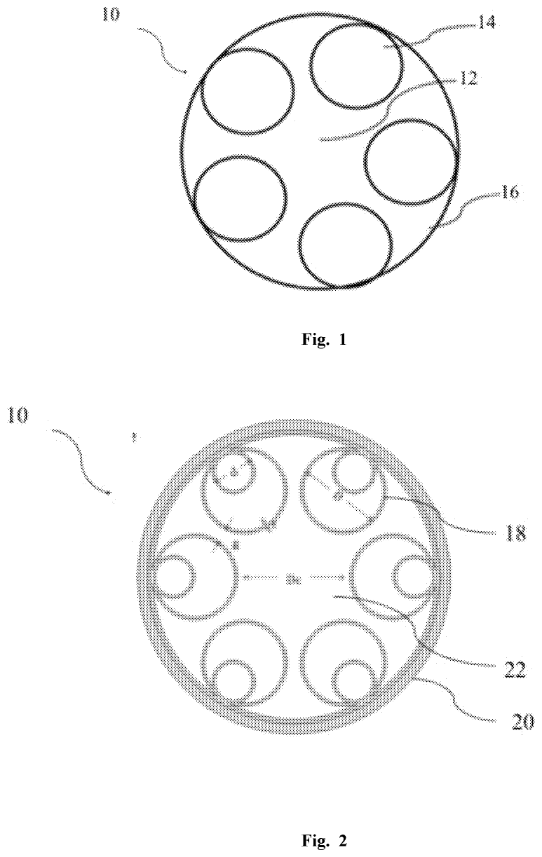

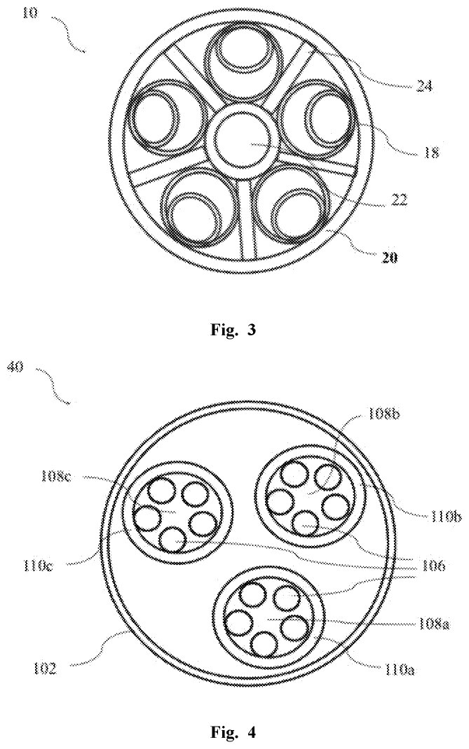

The principles of the present invention and their advantages are best understood by referring to FIG. 1 to FIG. 11. In the following detailed description numerous specific details are set forth in order to provide a thorough understanding of the embodiment of invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

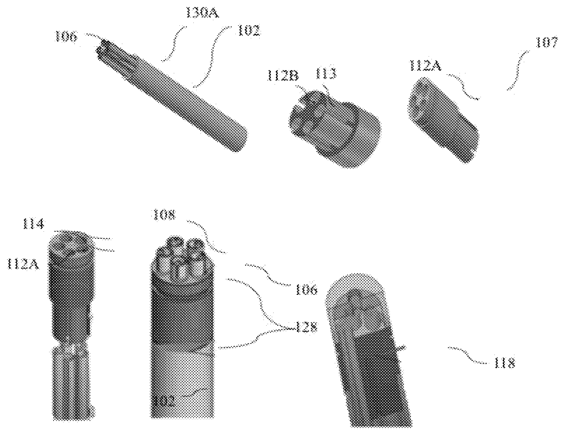

FIG. 4 illustrates a multicore anti-resonant fiber (MC-ARF) (40) with more than one air core region (108) formed inside a first cylindrical hollow tube (102). In particular, a plurality of second tubes (106) are placed inside each third cylindrical hollow tube (110a, 110b, 110c) of a plurality of third cylindrical hollow tube (110) to form the more than one air core regions (108a, 108b, 108c). Moreover, the first cylindrical hollow tube (102) is defined by a first diameter and a first thickness, the plurality of second tubes (106) are defined by a second diameter and the plurality of third cylindrical hollow tube (110) are defined by a third diameter and third thickness. Further, the first diameter and third diameter is greater than the second diameter and first diameter is greater than third diameter.

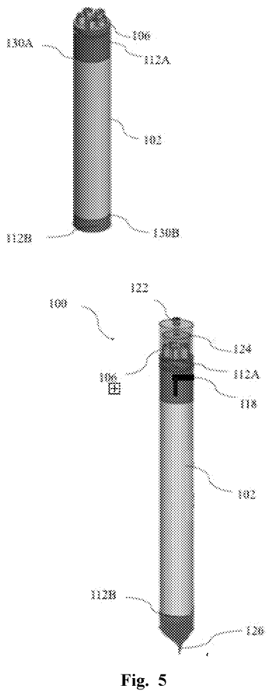

FIG. 5 illustrates a hollow core glass (100) with an integrated aligning element (112) is configured to hold the plurality of second tubes (106) at a predetermined position with respect to the first cylindrical hollow tube (102). In particular, the integrated aligning element (112) is a single component element. Moreover, the integrated aligning element (112) is configured to be inserted on at least one end (130) the first cylindrical hollow tube (102). Further, the integrated aligning element (112) has a plurality of through holes (114) for each second tube (106) of the plurality of second tubes (106) to protrude through the integrated aligning element (112).

In accordance with an embodiment of the present invention, when the integrated aligning element (112) is configured to be inserted at a top end (130A) of the first cylindrical hollow tube (102), the integrated aligning element (112) has a plurality of groove (113) features to hold each second tube of the plurality of second tubes (106).

In accordance with an embodiment of the present invention, when the integrated aligning element (112) is configured to be inserted at a bottom end of the first cylindrical hollow tube, the integrated aligning element (112) has a central hole positioned near the central axis of the hollow core glass preform assembly such that a perpendicular distance between a center of the central hole and the central axis is less than 0.5 mm.

In accordance with an embodiment of the present invention, the integrated aligning element (112) is inserted in 3 to 10% of longitudinal length of the first cylindrical hollow tube. Further, the integrated aligning element (112) comprises a circumferential groove configured to attach a holding mechanism. The plurality of through holes (114) of the integrated aligning element (112) incorporates the plurality of third cylindrical hollow tubes (110) of FIG. 4 to obtain an intermediate multicore HCF glass preform assembly which is further drawn to a MC-ARF (40).

In accordance with an embodiment of the present invention, the integrated aligning element (112) is one of a top integrated aligning element (hereinafter interchangeably referred as top plug) (112A) and a bottom integrated aligning element (hereinafter interchangeably referred as bottom plug) (112B). The multiple second tubes (106) are inserted into the first cylindrical hollow tube (102) which is aligned at their predefined position using either one or both of the top and bottom integrated aligning elements (112A and 112B).

Further, at least one end (130) comprises a first end (130A) for attachment of the top plug (112A) and a second end (130B) for attachment of the bottom plug (112B).

In accordance with an embodiment of the present invention, the hollow core glass preform assembly (100) as shown in FIG. 5 comprises a one or more spacer plate (124) placed above the protruded second tubes (106). In particular, one or more spacer plates (124) comprises a first pressure inlet (122) configured to enable application of positive pressure in the plurality of second tubes (106). Moreover, one or more spacer plate (124) can be a part of the top integrated aligning element (112) or can be separately placed above the top integrated aligning element (112) to seal the top end portion of the intermediate assembly of the hollow core fiber preform.

Further, the spacer plate (124) includes the first pressure inlet (122), used as a mechanism to provide individual pressure to each second tube (106). The different pressure is being applied in both the core region (108) and the second tubes (106) via integrated aligning element (112) in presence of one or more gases. The gases include but not limited to Ar and N2.

In accordance with an embodiment of the present invention, the integrated aligning element (112) as specified in FIG. 5 comprises the top plug (112A) and the bottom plug (112B). The top plug (112A) consists of a separate cross-sectional hole (114) corresponding to each second tube of the plurality of the plurality of the second tube (106). The bottom end surface of the bottom plug (112B) is completely sealed, forming a tapered shape of the bottom plug (112B) for drawing the hollow core fiber (126).

In accordance with an embodiment of the present invention, the hollow-core fibers (HCFs) guide light in air, rather than in glass. This means that HCFs have low latency, a low nonlinear coefficient, and a high damage threshold. Further, they can guide light at wavelengths where solid materials have high attenuation due to Rayleigh scattering, IR absorption, or photo darkening. The HCF can transmit high-power lasers, and are used in chemical and biomedical sensing.

In accordance with an embodiment of the present invention, a first cylindrical hollow tube (102) having a predefined wall thickness in which multiple cladding elements (second tubes) (106) are inserted to form a hollow core or air core region along the central longitudinal axis of the first cylindrical hollow tube (102). This is the large tube that forms the outer boundary of the hollow core region. It can be made of silica glass or other optically suitable materials.

In accordance with an embodiment of the present invention, the integrated aligning element (112) is a single component that holds the second tube (106) in place relative to the first cylindrical hollow tube (102). Further, the integrated aligning element is made up of silica glass which is of low cost or soft silica glass.

In accordance with an embodiment of the present invention, the integrated aligning element (112) can be a top plug (112A) and a bottom plug (112B). In particular, the top plug (112A) will act as aligning mechanism and also help to achieve individual pressurization of the second tubes (106) and the air core region (108). Moreover, the bottom plug (112B) holds the second tubes (106) (small diameter cylindrical cladding tube) at the bottom end (130B) of the first cylindrical hollow tube (102) so that the second tube (106) does not egress out (slip out) from the bottom end (130B) of the hollow core glass preform (100). Through the plurality of through holes (114) the second tubes (106) protrude.

In accordance with an embodiment of the present invention, the integrated aligning element (112) simplifies the alignment of second tubes (106) inside the first cylindrical hollow tube (102) by using a single, precisely designed component. This removes the need for multiple spacer rods, plates, or support tubes (24).

In accordance with an embodiment of the present invention, the method includes applying individual pressure to each second tube (106) and the hollow core region (108) using the integrated aligning element (112) with a central hole connected to the second pressure inlet port (118). Further, the plurality of through holes (114) could vary based on the number of second tubes (106). Different designs of hollow core fiber assembly are shown below in different images, number of plurality of through holes (114) and shape of the plurality of through holes (114) in the integrated aligning element (112) is designed based on the required hollow core pattern.

In an embodiment of the invention the shape of the holes includes but is not limited to circular, slotted, or elliptical to accommodate different second tube shapes.

In accordance with an embodiment of the present invention, the one or more spacer plate (124) can be a part of the top of the top plug or can be separately placed above the top plug (112A) to seal the top end portion (130A) of the intermediate assembly of the HCF preform. In particular, the spacer plate (124) includes a first inlet (122), used as a mechanism to provide individual pressure to each second tube (AS tube) (106).

In general, the Anti-resonant fibers (ARFs) are HCFs that have a microstructure consisting of a hollow core surrounded by a cladding formed of thin webs of material, usually fused silica, that provide an anti-resonant reflection condition to the light being guided in the hollow core. The AR-HCF can have low nonlinearity and high damage threshold. The AR-HCF can have a wide transmission bandwidth and low loss.

In accordance with an embodiment of the present invention, to achieve high confinement and very low scattering loss in the HCF, nested anti-resonant tubes (second tubes) (106) are placed to form the air core region. More than one nested anti-resonant cladding tubes (second tubes) (106) is placed in a first cylindrical hollow tube (102). Further, the anti-resonant tubes (second tubes) (106) are formed of more than two concentric arrangements of cladding tubes. Many other configurations of cladding tubes (nested and not nested) can be used to provide an equivalent orthogonal loss differential for maintaining light polarisation. Nested Anti-resonant HCF is one of double nested anti-resonant HCF.

In accordance with an embodiment of the present invention, dual-core anti-resonant fibers (DC-ARFs) comprises two air core regions formed inside a first cylindrical hollow tube. Further, the two hollow core fiber preform are inserted into a first cylindrical hollow tube (102) which is aligned at their predefined position using the top and bottom plug (112) designed as per the present disclosure.

In accordance with an embodiment of the present invention, different shapes and sizes of the second tube (106) can be made in single or multiple steps (Double, triple, etc.,). In particular, the plurality of second tubes (106) (interchangeably referred as anti-resonant tubes OR the small diameter cylindrical cladding tubes) are placed inside the first cylindrical hollow tube (interchangeably referred as jacket cladding tube) (102) in a predefined arrangement to form a hollow core region (108) along the central longitudinal axis of the first cylindrical hollow tube (102). Further, the second tube (106) can be double nested tubes or multi-nested tubes or any combinations to achieve desired waveguide parameters of the hollow core fiber.

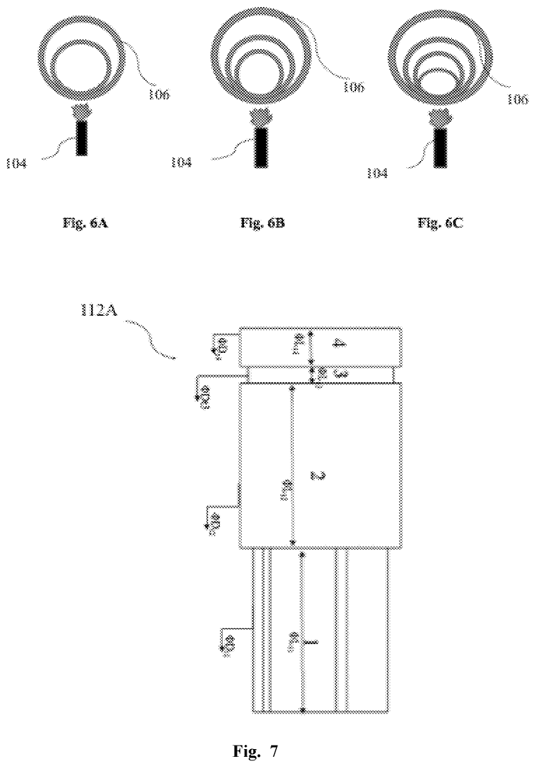

In accordance with an embodiment of the present invention, the double nested AS tubes are formed by fusing two tubes of different diameter with the help of a hydroxy burner (104) as shown in FIG. 6A. In particular, the Anti-resonant tubes (106) usually consist of materials transparent to the operating light, such as glass (especially doped or undoped SiO₂), plastics (especially polymers), composites or crystalline materials. The diameter can vary to optimize the hollow core region's functionality, from a smaller size to micro-structures.

In accordance with an embodiment of the present invention, the tube shape includes but is not limited to cylindrical or other geometric shapes.

FIG. 6B and FIG. 6C illustrates the fusing mechanism of the second tubes (106), where each second tube of the plurality of second tubes (106) includes but is not limited to a double nested tube and a triple nested tube or four tubes are nested. Further, the double nested tube and triple nested tube includes but is not limited to cylindrical tube and a semi cylindrical tube (cut from cylindrical tube).

In accordance with an embodiment of the present invention, a nested anti-resonant node less fiber (NANF) refers to a type of hollow-core optical fiber (126) where multiple concentric layers of cladding tubes are arranged in a nested structure as shown in FIG. 6, designed to minimize light loss by utilizing the principle of anti-resonant reflection, effectively guiding light through the hollow core without any “nodes” where the light intensity would normally drop to zero, allowing for very low attenuation and high transmission capabilities over long distances. The hollow core optical fiber (126) consists of a hollow core (108) surrounded by multiple layers of cladding tubes with precisely engineered diameters and spacing, creating a nested pattern. Light is guided by reflecting off the interfaces between the cladding tubes at specific wavelengths where the reflections interfere destructively, preventing light from escaping into the core. Unlike conventional hollow-core fibers, NANF design avoids the formation of “nodes” in the light field distribution, leading to more efficient light transmission.

In accordance with an embodiment of the present invention, a double nested Anti-resonant node less fiber (DNANF) is a type of hollow-core optical fiber that utilizes a unique design with multiple nested layers of cladding tubes, engineered to minimize light loss by creating an “anti-resonant” effect, where light is effectively confined within the hollow core due to destructive interference, resulting in extremely low attenuation levels, often comparable to standard solid-core fibers, “node less” indicates that the fiber design avoids any points where light could be significantly disrupted or scattered within the core.

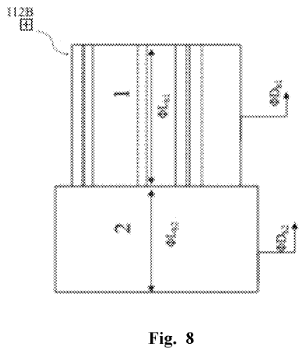

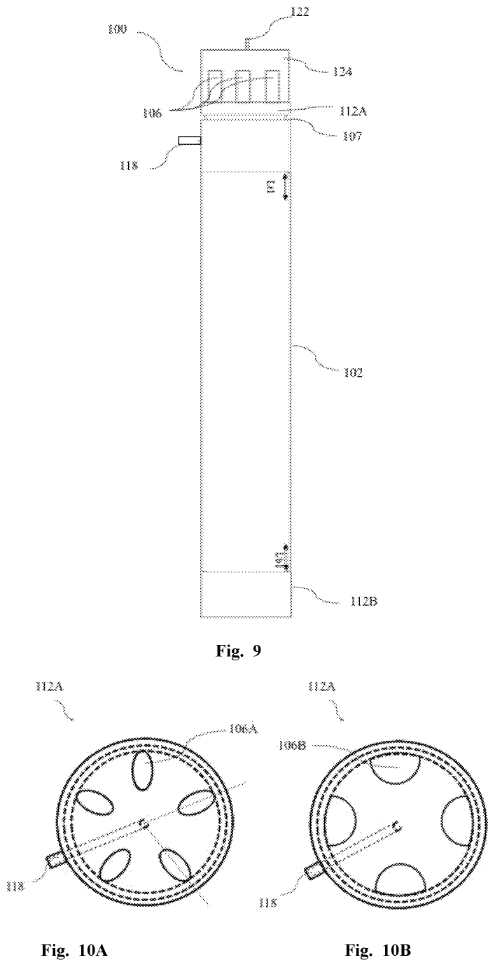

FIG. 7, FIG. 8 and FIG. 9 illustrate the dimensions of the top plug (112A), the bottom plug (112B) and the hollow core perform (100) respectively. In an aspect of the present invention there is provided a method of manufacturing the hollow core fiber (126).

In accordance with an embodiment of the present invention, the terms
D, L signifies diameter and length,
subscript c, t, b signifies first cylindrical hollow tube (102), top plug (112A),
bottom plug (112B),
second subscript 1, 2 . . . indicates parts number as shown in FIG. 7, FIG. 8 and FIG. 9.

Further, the top plug (112A) and bottom plug (112B) (integrated aligning element) can be manufactured by drilling in case of simple circular shape or made by melting quartz and pouring in Mold (casting method) in terms of non-circular resonant tubes. Similarly, the different parts of top and bottom plugs (112) can be made as a single unit or multiple units later fused together.

Overall dimensional relationship
1. Dt1=Db1=Dc_inner−2*clearance (clearance will be 0.2 to 2.5 mm), where Dc_inner is the inner diameter of the first cylindrical hollow tube (102)
2. Dt2=Dt4=Db2=Dc_outer, where Dc_outer is the outer diameter of the first cylindrical hollow tube (102)
3. Lt1=Lb1 (Range 2 cm to 10 cm)
4. Lt2=Lt3+Lt4
5. Lt4=Lb2
6. Lt3 and Dt3 may vary based on preform holding arrangement in draw tower

In accordance with an embodiment of the present invention, the length of each second tube (interchangeably referred as anti-resonant tube or small diameter cylindrical tubes) (106)=Lc+Lt1+Lt2+Lt3+Lt4+100 mm. A small axial central hole of diameter in the range of 2 mm to 5 mm pass through length Lt1 and half the length of Lt2. This pathway connects with radial holes through part 2. This perpendicular pathway will be used to pressurize the cylinder. In top plug (112A), there will be circular/elliptical (or any required shape to protrude small diameter cylindrical tubes) pattern of holes to allow the anti-resonant tubes (106) pass through from part 1 to part 4 (Lt1, Lt2, Lt3, Lt4). In bottom plug (112B), there will be circular pattern of holes (113) (or any required shape to insert and hold the small diameter cylindrical tubes) to allow the anti-resonant tubes (106) pass through only part 1 (Lb1) not through part 2 (Lb2).

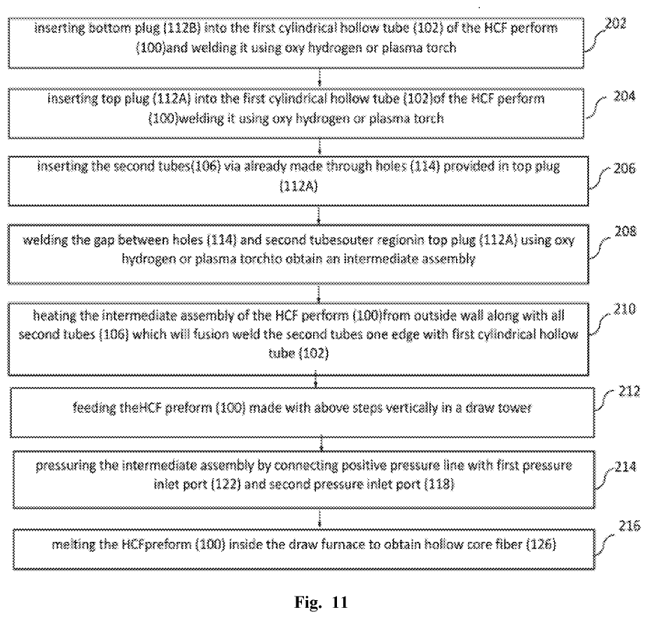

In accordance with an embodiment of the present invention, each hole (113, 114) in the circular pattern of top plug (112A) and bottom plug (112B) may be of any shape oval, elliptical, semicircular etc and of any number as shown in FIG. 10A and FIG. 10B which illustrates a top view of top plug (112A) for elliptical second tube (106A) in circular pattern and top view of top plug (112A) for semicircular second tube (106B) in circular pattern.

Further, the circular pattern of holes passing through top and bottom plug is decided based on the number, placement and design of the resonant tubes placed inside the cylinder. For example, top view of top plug for five numbers of elliptical anti-resonant tubes (106A) and another case four numbers of semicircular anti-resonant tubes (106B) are shown in FIG. 10A and FIG. 10B.

In accordance with an embodiment of the present invention, when the cross-sectional shape of the second tubes (106) are a combination of circular and semi-circular, the through holes in the top integrated aligning element (112A) is respectively same to accommodate the second tubes (106) while bottom integrated aligning element (112B) may not have any hole and may be used for sealing the bottom end of the first cylindrical tube (102). Further, the top integrated aligning element (112A) may individually handle the alignment as well as pressurization of the HCF glass preform assembly (100).

In accordance with an embodiment of the present invention, the top plug comprises a circumferential groove (interchangeably referred as handle portion) (107) where handles are attached to vertically hold the HCF preform (100) while drawing HCF (126) in a draw furnace. In particular, the circumferential groove (107) around the integrated aligning element (112) to facilitate attachment to the holding mechanism (when the aligning element is placed at top of the HCF preform assembly). The circumferential groove (107) could be at the top, middle, or bottom of the integrated aligning element depending on the assembly design.

In accordance with an embodiment of the present invention, the cross-sectional width of the groove (113) is between 2 mm to 6 mm (preferably 3 mm). Further, the handle portion (107) could be conFig. d for clamping, screwing, wielding or adhesive attachment.

In accordance with an embodiment of the present invention, the gases include Ar or Nitrogen, or combination of gases are used to pressurize each individual second tube (106) and the air core region (108) of the hollow core fiber preform assembly as shown in FIG. 5 while drawing the HCF to obtain hollow core fiber (126).

In accordance with an embodiment of the present invention, the method of manufacturing the hollow core optical fiber (126) comprises the steps of inserting bottom plug (112B) into the a first cylindrical hollow tube (102) of the HCF perform and welding (128) it using oxy hydrogen or plasma torch (202); inserting top plug (112A) into the first cylindrical hollow tube (102) of the intermediate assembly of the HCF perform; welding (128) it using oxy hydrogen or plasma torch; inserting the second tubes (106) made already through the holes (114) provided in top plug (112A); welding (128) the gap between holes (114) and second tubes outer diameter in top plug (112A) using oxy hydrogen or plasma torch; heating the intermediate assembly (100) of the HCF perform from outside wall along with all second tubes inside the first cylindrical hollow tube which will fusion weld (128) the resonant tubes one edge with intermediate assembly; feeding the hollow core preform assembly (100) made with above steps is vertically in a draw tower; pressuring the intermediate assembly by connecting positive pressure line with second inlet port (118) provided in top plug (112A); and inserting the hollow core preform inside the draw furnace and hollow core optical fiber (126) drawn.

In accordance with an embodiment of the present invention, the preform components of the preform consist of different silica glass qualities, the viscosity of the components increasing from the outside to the inside to a first order approximation. In addition to fluorine, other dopants such as Al₂O₃, nitrogen, chlorine, and hydroxyl groups can also be used to adjust the viscosity. The jacket tube or the second tube may contain any combination of dopants (down dopants or up dopants) to obtain a desired hollow core optical fiber (126).

In accordance with an embodiment of the present invention, during elongation, the primary preform is stretched. The stretching can take place without simultaneous collapse. Elongation can take place true to scale so that, for example, the shape and arrangement of components or constituents of the primary preform is reflected in the elongated end product. During elongation, however, the primary preform can also be drawn not true to scale and its geometry can be modified.

In accordance with an embodiment of the present invention, the integrated aligning element (112) includes a single component that holds the second tube (106) in place relative to the first cylindrical hollow tube (102). The silica glass has properties as mentioned in Table 1:

TABLE 1

| Density | Kg/cm³ | 2.2 × 10³ |
|---|---|---|
| Strength | KHN100 | 570 ± 10 |
| Tensile Strength | Pa(N/m³) | 4.8 × 10⁷ |
| Compression Strength | Pa | >1.1 × 10⁹ |
| (20 °C-300 °C) Coefficient of | cm/cm°C | 5.5 × 10⁻⁷ |
| Thermal Expansion | | |
| (20 °C) Thermal | W/m°C | 1.2 to 1.5 |
| Conductivity | | |
| (20 °C) Specific Heat | J/kg°C | 660 ± 10 |
| Softening Point | °C | 1630 ± 10 |
| Annealing | °C | 1180 ± 10 |

a. Soft glass typically consists of approximately 70-74% silica (SiO₂), 12-16% soda (Na₂O), and 5-10% lime (CaO).
   i. thermal conductivity of fused silica, a type of soft silica glass, is 0.5 to 2 W/m° K at 25 °C
   ii. The density of soft silica glass, also known as fused silica, is approximately 2 to 2.5 g/cm3
b. One or more type of Polymer
c. Chalcogenide glass
   i. Density between 3 to 5 grams per cubic centimeter (g/cm3)
   ii. a very low thermal conductivity, usually on the order of 0.2 to 1 W/m-K

In accordance with an embodiment of the present invention, the plurality of holes (114) in the integrated aligning element (112) through which the second tubes (106) protrude. The plurality of holes (114) can vary based on the number of second tubes (106) as illustrated in FIG. 4 and FIG. 10A and FIG. 10B.

In accordance with an embodiment of the present invention, the shape of the plurality of holes (114) includes, but not limited to circular, slotted, or elliptical to accommodate different tube shapes as illustrated in FIG. 10A and FIG. 10B.

In accordance with an embodiment of the present invention, a groove (113) in the bottom plug (112B) holds the second tube (106) at the bottom end. In particular, the groove (113) feature is of similar shape as of second tube (106) formed in bottom plug (112B) placed at the bottom of the HCF preform (100) assembly. Further, the bottom end surface of the bottom plug (112B) is placed at the bottom of the hollow core fiber preform assembly (100) is completely sealed so that the plurality of second tubes (106) do not protrude out.

In accordance with an embodiment of the present invention, the plurality of holes in the integrated aligning element, positioned near the central longitudinal axis, allows for controlled application of pressure. The shape of the hole includes but is not limited to round, square, or oval. The size of the hole can vary for different pressures or application needs. The cross-sectional area of the central hole is between 2% to 5% of the cross-sectional area of the first hollow cylindrical tube.

In accordance with an embodiment of the present invention, the spacer plate includes but is not limited to one, two, three, four, fiver and so on. above the protruding second tubes (106) that can apply positive pressure to the second tube (106). The purpose of the one or more spacer plate is to provide variable pressure in all the second tubes as well as different pressure in the one or more nested third tube inside the second tube.

In accordance with an embodiment of the present invention, the material for the spacer plate includes but is not limited to glass, metal, or polymer. The shape of the spacer plate includes but is not limited to flat, stepped or raised sections to interact with the second tubes.

The application of positive pressure to the second tube and the hollow core region. In particular, the pressure inlet could be a tube or valve system attached to the spacer plate and the central hole of the integrated aligning element. Further, the pressure can be individual or uniform across all second tubes. Pressure can be different in the air core region as compared to the pressure applied in the second tubes (106).

In accordance with an embodiment of the present invention, the diameter of the second tube should be smaller than the first diameter. The diameter of the second tubes (106) range from sub-millimeter to several millimeters, based on design requirements. In an exemplary example, the diameter is between 3 mm to 10 mm. The diameter of second tubes (106) may vary depending on the number of second tubes (106) and inner diameter of the first cylindrical hollow tube (102). One of the one or more regions of the second tubes are doped to alter the optical properties. The doping can include materials like alumina, phosphates, or other rare-earth dopants for tailoring optical properties.

FIG. 11 illustrates a process for preparation of hollow core fiber (126).

In step (202) inserting a bottom plug (112B) into the first cylindrical hollow tube (102) of the HCF perform (100) and welding it using oxy hydrogen or plasma torch.

In step (204) inserting top plug (112A) into the first cylindrical hollow tube (102) of the HCF perform (100) and welding it using oxy hydrogen or plasma torch.

In step (206) inserting the second tubes (106) via already made through holes (114) provided in top plug (112A).

In step (208) welding the gap between holes (114) and the second tube outer region in top plug (112A) using oxy hydrogen or plasma torch to obtain an intermediate assembly. In step (210) heating the intermediate assembly of the HCF perform (100) from outside the wall along with all second tubes which will fusion weld the second tubes one edge with the first cylindrical hollow tube (102).

In step (212) feeding the HCF preform (100) made with above steps vertically in a draw tower.

In step (214) pressuring the intermediate assembly by connecting the positive pressure line with the first pressure inlet port (122) and the second pressure inlet port (118) provided in top plug (112A).

In step (216) melting the hollow core preform (100) inside the draw furnace to obtain the hollow core fiber (126).

Advantageously, the hollow optical core preform minimizes material wastage by efficiently using differential pressure technique via the multiple inlets and alignment systems that improve drawing performance of the hollow core fiber (126). Further, the hollow core fiber preform structure, combined with the positive pressure system, ensures that the resulting hollow-core fiber exhibits minimal confinement loss and low attenuation.

Unlike conventional spacer rods, plates, or support tubes that perform only positional alignment, the integrated aligning element of the present invention performs multiple interdependent technical functions within a single monolithic component. Specifically, the integrated aligning element simultaneously (i) defines and fixes the radial and angular positions of the plurality of second tubes relative to the first cylindrical hollow tube, (ii) seals at least one longitudinal end of the preform assembly, and (iii) provides discrete fluidic pathways enabling individual and differential pressurization of the hollow core region and each second tube during draw. These combined functions are structurally and operationally inseparable in the disclosed element and are not achievable through a mere aggregation of independent spacers or alignment components known in the prior art.

Advantageously, the integrated aligning element enables stable drawing of the hollow core preform assembly over a substantially greater fraction of the preform length compared to known techniques. Whereas conventional slit-based or resin-sealed assemblies typically become unusable after approximately 60-70% of the preform length due to premature sealing, collapse, or deformation, the present invention enables drawing over more than 90% of the preform length under controlled pressure conditions. This reduction in unusable preform length represents an unexpected technical result arising from the specific structural integration of alignment and pressurization features within a single component.

The prior art emphasizes either distributed spacing elements positioned along the preform length or post-assembly gap filling using auxiliary materials, both of which increase assembly complexity and introduce variability during thermal drawing. In contrast, the present invention eliminates intermediate spacing structures and filler materials altogether by localizing alignment and pressurization control to an end-mounted integrated aligning element, thereby simplifying assembly while improving draw stability.

Furthermore, known alignment structures used in solid-core or photonic crystal fiber preforms do not address the unique challenges associated with nested anti-resonant hollow core fibers, including differential pressure control between multiple concentric hollow regions.

Importantly, the alignment accuracy achieved by the integrated aligning element is functionally dependent on its pressurization architecture, such that removal or modification of either feature would compromise the other. For example, the positional stability of the second tubes during draw is maintained by internal pressure forces applied through the same structural pathways that define tube placement.

The disclosed preform assembly and method further provide significant manufacturing advantages, including reduced component inventory, lower assembly time, and improved yield consistency. These advantages have direct implications for scalability and cost-effective production of hollow core optical fibers, factors that are critical in commercial deployment.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

It will be apparent to those skilled in the art that other embodiments of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope of the invention. It is intended that the specification and examples be considered as exemplary, with the true scope of the invention being indicated by the claims.

What is claimed for:

1. A method for manufacturing a hollow core optical fiber (126) having a hollow core region (108) extending along a longitudinal axis of the hollow core optical fiber (126), the method comprising:
forming an intermediate hollow core glass preform assembly (100), where the intermediate hollow core glass preform assembly (100) comprising:
a first cylindrical hollow tube (102);
a plurality of second tubes (106) disposed inside the first cylindrical hollow tube (102) to form the hollow core region (108); and
an integrated aligning element (112) configured to be inserted at one of the end (130) of the first cylindrical hollow tube (102) for holding each second tube of the plurality of second tubes (106); and
drawing the intermediate hollow core glass preform assembly (100) in a draw furnace to obtain the hollow core optical fiber (200) in presence of positive pressure, wherein the plurality of second tubes are aligned without intermediate spacing elements positioned along the longitudinal length of the first cylindrical hollow tube.

2. The method as claimed in claim 1, wherein step of holding the plurality of second tubes (106) comprises arranging each second tube at a predetermined position with respect to the first cylindrical hollow tube (102).

3. The method as claimed in claim 1, wherein the method further comprising, stretching the intermediate hollow core glass preform to obtain a low diameter hollow core glass preform.

4. The method as claimed in claim 1, wherein the method further comprises, applying individual pressure in the hollow core region (108) and each second tube of the plurality of second tubes (106).

5. The method as claimed in claim 1, wherein positive pressure is applied to the hollow core region (108) via a central hole formed in the integrated aligning element (112).

6. The method as claimed in claim 1, wherein each second tube of the plurality of second tubes (106) protrudes through a corresponding through hole (114) formed in the integrated aligning element (112).

7. The method as claimed in claim 1, wherein each second tube of the plurality of second tubes (106) protrudes through a plurality of through holes (114) configured in the integrated aligning element (112), wherein the integrated aligning element (112) is formed as a single monolithic body and is not assembled from multiple separable alignment or pressurization components.

8. The method as claimed in claim 1, wherein one or more of the following conditions is satisfied:
positional stability of the plurality of second tubes (106) during drawing is maintained by pressure forces applied through the same structural features that define alignment of the plurality of second tubes (106);
all alignment and pressurization of the plurality of second tubes (106) is performed exclusively from a single longitudinal end of the intermediate hollow core glass preform assembly (100);
at least 85% of a longitudinal length of the intermediate hollow core glass preform assembly (100) is drawable prior to collapse, sealing, or loss of pressure control;
positive pressure applied to at least two of the plurality of second tubes (106) differs by at least 5% during drawing; and
no adhesive, resin, or gap-filling material is present between the plurality of second tubes (106) and the first cylindrical hollow tube (102) during drawing.

9. The method as claimed in claim 1, wherein an individual positive pressure is applied to each protruded second tube of the plurality of second tubes (106) via a pressure inlet configured in one or more spacer plates of the intermediate hollow core glass preform assembly (100).

10. The method as claimed in claim 1, wherein the integrated aligning element (112) is configured to be inserted at a bottom end (130B) of the first cylindrical hollow tube (102)

11. The method as claimed in claim 1, wherein each second tube of the plurality of second tubes (106) are fixed in a plurality of groove (113) in the integrated aligning element (112).

12. The method as claimed in claim 1, wherein the method further comprises applying one or more coating layers on the drawn hollow core optical fiber (126) to obtain a coated optical fiber.

13. The method as claimed in claim 1, wherein a coating thickness of the one or more coating layers is in a range of 20 microns to 60 microns.

14. The method as claimed in claim 1, wherein the hollow-core optical fiber (200) has at least one of (i) a minimum confinement loss of a fundamental mode of an optical signal propagating in the hollow-core optical fiber is less than or equal to 0.05 dB/km at 1550 nm or (ii) an attenuation of less than or equal to 0.1 dB/km at 1550 nm.

15. An intermediate hollow core glass preform assembly (100) comprising:
a first cylindrical hollow tube (102);
a plurality of second tubes (106) disposed inside the first cylindrical hollow tube (102) to form the hollow core region (108); and
an integrated aligning element (112) configured to be inserted at one of the end (130) of the first cylindrical hollow tube (102) for holding each second tube of the plurality of second tubes (106).

16. The intermediate hollow core glass preform assembly (100) as claimed in claim 15, an individual positive pressure is applied to each protruded second tube of the plurality of second tubes (106) via a pressure inlet configured in one or more spacer plates of the intermediate hollow core glass preform assembly (100).

17. The intermediate hollow core glass preform assembly (100) as claimed in claim 15, wherein each second tube of the plurality of second tubes (106) protrudes through a plurality of through holes (114) configured in the integrated aligning element (112).

18. The intermediate hollow core glass preform assembly (100) as claimed in claim 15, wherein the integrated aligning element (112) is defined by at least one of:
defines a separate pressure inlet for each second tube (106) and a separate pressure inlet for the hollow core region (108);
(b) is removably inserted and is not fused to the first cylindrical hollow tube (102); and
(c) maintains structural integrity at temperatures exceeding 1800 °C during drawing.

19. The intermediate hollow core glass preform assembly (100) as claimed in claim 15, wherein:
the integrated aligning element (112) is configured to be inserted at a top end (130A) or a bottom end (130B) of the first cylindrical hollow tube (102); and
one or more coating layers are disposed on an outer surface of the cladding region, the total coating thickness of the coating layers being in a range of 20 microns to 60 microns.

20. A hollow core optical fiber (200) comprising:
a cladding region;
a hollow core region (108) extending along a longitudinal axis of the hollow core optical fiber (200); and
a plurality of tubes (106) disposed around the hollow core region (108) and arranged in a predetermined spatial configuration defined by an integrated aligning element (112) during fabrication,
wherein the hollow core optical fiber (200) exhibits at least one of:
(i) a minimum confinement loss of a fundamental mode less than or equal to 0.05 dB/km at 1550 nm, or
(ii) an attenuation of less than or equal to 0.1 dB/km at 1550 nm.
